(19) United States
(12) Patent Application Publication
(10) Pub. No.: US 2025/0373815 A1
(43) Pub. Date: Dec. 4, 2025

(54) METHODS AND SYSTEMS FOR ENHANCED IMAGE AND VIDEO CAPTURE AND COMPRESSION

(71) Applicant: Adeia Guides Inc., San Jose, CA (US)

(72) Inventor: Tao Chen, Palo Alto, CA (US)

(21) Appl. No.: 18/679,875

(22) Filed: May 31, 2024

(51) Int. Cl. H04N 19/159; G06V 10/44; H04N 19/59

(52) U.S. Cl. CPC H04N 19/159; G06V 10/44; H04N 19/59

(57) ABSTRACT

Systems and methods are described for encoding still images and videos, particularly through the use of inter-prediction techniques that leverage still images as reference frames for video encoding. Image data is receiving, the image data comprising a first video having a capture duration, and a first still image captured during the capture duration. The first still image is image encoded for storage. The first video is video encoded for storage, via inter-prediction using a reference frame as a surrogate intra-coded (I) frame, the reference frame comprising the first still image.

### BACKGROUND

The present disclosure relates generally to the technical field of digital image and video processing. More specifically, the present disclosure is directed to methods and systems for encoding still images and videos, particularly through the use of inter-prediction techniques that leverage still images as reference frames for video encoding.

### SUMMARY

In recent years, advancements in mobile technology have significantly enhanced the capabilities of digital cameras integrated into smartphones and other mobile devices. These advancements have enabled features like the capture of a short video clip, typically a few seconds long, along with a high-resolution still image. These combined media formats offer a more immersive viewing experience by adding motion and sound to traditional still photos.

As camera quality continues to improve, however, the resolution of both still images and video recordings has increased. This increase in resolution enhances the clarity and detail of the photographs and videos but also leads to larger file sizes. High-resolution images and high-frame-rate video require substantial data storage, presenting significant challenges as the amount of data generated by these devices grows exponentially.

One potential concern in the development and widespread adoption of integrated multimedia capture technology is the efficient management of storage space. As the quality of camera sensors improves, and the resolution of the images and videos they produce increases, the memory requirements for storing these files also increase. This escalation in required storage space could pose a potential problem for device manufacturers and users, particularly as the demand for higher quality and more interactive and integrated media formats continues to rise.

Increasing file sizes can act to strain the internal memory of devices, limiting the number of photos and videos that can be stored. This can lead users to compromise on the number of photos and videos captured, or force users to invest in additional storage solutions, such as cloud services or external memory devices. Moreover, the larger file sizes can impact device performance, leading to slower processing speeds and increased power consumption.

The level of adoption of, and engagement with, virtual and augmented reality and spatial computing experiences increases among device manufacturers and users. This compounds the issue of increasing capture quality for integrated multimedia capture and storage. This is particularly the case since such technology typically requires multiple captured and stored perspectives, for example one per eye of a user of an artificial reality device.

Some approaches can include using external storage, and improving cloud services for off-device storage. However, these approaches may involve certain trade-offs. External and cloud storage approaches attempt to address limited internal memory but can introduce issues related to data security, access speed, and increased dependency on internet connectivity.

Thus, there remains a need for improved systems and methods that allow for the efficient storage and processing of high-quality integrated multimedia capture technologies, without compromising on the quality of the still image and video components. There also remains a need to address concerns related to storage capacity, device performance, and overall user experience relating to integrated multimedia capture technologies.

According to the systems and methods described herein, image data is received, the image data comprising a first video having a capture duration, and a first still image captured during the capture duration. For example, the image data may be received at or via a server from a user device, or at a processor of a said user device, for example captured by an image capture assembly of the user device. The term “image data” will be understood to mean any suitable data comprising an image, including the first still image and the first video, and may comprise any suitable additional images, videos, data or information such as meta data associated with at least one of the first still image or the first video. In some examples the image data comprises stereoscopic image data, and the first still image is at least a portion of a stereoscopic image, and the first video is at least a portion of a stereoscopic video. The first still image may be image encoded, for example for storage. Said image encoding may be by way of any suitable image encoding, for example by way of any suitable image codec. Said storage may be any suitable transitory or non-transitory storage and may in some examples be local to a user device, or at an extendible storage device linked to the user device, or may be remote to the user device, for example at a remote server.

In examples wherein the storage is remote to a user device, at least one of said image encoding or said storing may further comprise transmitting the first still image, from the user device, to at least one of a remote encoding location or a remote storage location. The first video is encoded via inter-prediction, for example for storage. Said inter-prediction uses a reference frame as a surrogate intra-coded (I) frame for said video encoding, the reference frame comprising the first still image. It will be appreciated therefore that, in an example, said video encoding does not comprise generating an I-frame from any video frames of the first video. The use of the first still image as a reference frame for inter-prediction encoding of video frames of the first video thereby obviates the separate independent encoding of any of the video frames as I-frames. In some examples, the surrogate I-frame is considered “surrogate” because, while it serves the same function an I-frame serves in a typical decoding process used for inter-coded frames, the surrogate I-frame is not generated by way of intra-coding a frame from the video in question. In some examples, the surrogate I-frame may be encoded from a still picture, which for example may be higher resolution or quality than the frames from a corresponding video. As such, other than the surrogate I-frame, all of the encoded video frames may be predicted frames, for example any suitable combination of predicted (P) or bidirectional (B) predicted frames, therefore reducing the storage requirements for the encoded video when compared with a video encoding which includes intra-frame encoding of a video frame of the first video. Said use of the first still image as at least a part of the reference frame for said video encoding may comprise decoding the encoded first still image, the reference frame in such examples comprising the decoded first still image. Said video encoding may be by way of any suitable video encoding process, for example by way of any suitable video codec. Said storage may be any suitable transitory or non-transitory storage and may in some examples be local to a user device, or at an extendible storage device linked to the user device, or may be remote to the user device, for example at a remote server.

In examples wherein the storage is remote to a user device, at least one of said video encoding or said storing may further comprise transmitting the first video, from the user device, to at least one of a remote encoding location or a remote storage location. In some examples, the image encoding of the first still image and the video encoding of the first video use different codecs. In some examples, the first still image and the first video may be captured at the same image sensor of an image capture assembly, which may in some examples be a multi-view imaging assembly.

In some examples the image data may further comprise a second video captured simultaneous with the first video, and a second still image captured simultaneous with the first still image. In some such examples, the image encoding may further comprise image encoding the second still image. In some such examples, the video encoding further comprises video encoding the second video via inter-prediction, for example for storage. Said inter-prediction uses a reference frame as a surrogate I-frame, the reference frame comprising at least one of: the first still image; or the second still image. It will be appreciated therefore that said video encoding does not comprise generating an I-frame from any video frames of the first video. The use of the first still image as a reference frame for inter-prediction encoding of video frames of the first video thereby obviates the separate independent encoding of any of the video frames as I-frames. As such, all of the encoded video frames may be predicted frames, for example any suitable combination of predicted (P) or bidirectional predicted (B) frames, therefore reducing the storage requirements for the encoded video compared with a video encoding which includes intra-frame encoding of a video frame of the first video. Said use of at least one of the first still image or the second still image as at least a part of the reference frame for said video encoding may comprise decoding at least one of the encoded first still image or the second still image, the reference frame in such examples comprising at least one of the decoded first still image or the decoded second still image. It will be appreciated that the reference frame for video encoding the second video may be the same or different to the reference frame for video encoding the first video.

In some examples in which the image data comprises stereoscopic image data, the first still image and the second still image may be still image components of a stereoscopic image pair, captured at different image sensors of a multi-view imaging assembly. In some examples in which the reference frame for video encoding the second video is the same as the reference frame for video encoding the first video, said video encoding of the second video may comprise inter-view prediction of at least one video frame of the second video using the first still image as a reference picture. Inter-view prediction may therefore in some examples allow the video encoding of the second video to use the first video as a reference. Use of the same reference frame for encoding the first video and the second video may in some such examples reduce the processing requirements for said video encoding, for example by requiring the decoding of only one of the encoded first still image or the encoded second still image. Said video encoding may be by way of any suitable video encoding process, for example by way of any suitable video codec. Said storage may be any suitable transitory or non-transitory storage and may in some examples be local to a user device, or at an extendible storage device linked to the user device, or may be remote to the user device, for example at a remote server.

In examples wherein the storage is remote to a user device, at least one of said video encoding or said storing may further comprise transmitting the second video, from the user device, to at least one of a remote encoding location or a remote storage location. In some examples, different codecs are used for the image encoding of the first second still image (and optionally the second still image) and the video encoding of the first video (and optionally the second video). In some examples, the second still image and the second video may be captured at the same image sensor of an image capture assembly, which may in some examples be a multi-view imaging assembly.

In some examples, the second still image is image encoded using inter-view prediction. The inter-view prediction may use the first still image as a reference picture. In examples wherein the first still image and the second still image are captured by, or received from, corresponding image sensors of a multi-view imaging assembly, the first still image may be usable as a reference picture for inter-view prediction encoding of the second still image. Inter-view prediction of the second still image in this manner may in some examples reduce the memory requirements for storing the encoded second still image compared with examples wherein the second still image is image encoded independently of the first still image. Examples will be appreciated wherein both the first still image and the second still image are image encoded independently of one another.

In some examples, an image capture device, such as an image capture device of a multi-view imaging assembly may capture the first still image using one or more first image capture parameters. A different image capture device, such as within the multi-view imaging assembly, may capture the second still image using one or more second image capture parameters different to the first image capture parameters. The first and second image capture parameters may be any suitable image capture parameters, for example: a focal length; an aperture size; a sensor size; a resolution; a zoom type; a lens type; an image stabilization; a shutter speed; an ISO sensitivity; a focus system; a field of view; a depth of field; dynamic range; color gamut. The term “one or more second image capture parameters different to the first image capture parameters” will be understood to mean different respective values of the same image capture parameter type. By way of example, in cases where the first and second image capture parameters have the image capture parameter type “resolution”, the first image capture parameter may be 48 MP, and the second image capture parameter may be 12 MP.

In some examples, wherein the image capture parameter type is “lens type”, the first image capture parameter may be wide-angle and the second image capture parameter may be ultra wide-angle. Any suitable combination of parameter types having different corresponding values for capture of the first and second still images will be appreciated. In examples wherein the image encoding of the second still image comprises inter-view prediction using the first still image as a reference picture, the image encoding may comprise adjusting at least one of the first still image or the second still image. Said adjusting may comprise any suitable adjustment, such as for example one or more selected from: spatial alignment; cropping; scaling; resampling.

In examples wherein the first still image and the second still image are captured using different image capture parameters, the first still image and the second still image may for example be captured at different sizes, scales, resolutions or field of view. Any suitable adjustment will be appreciated which aligns one or more visual parameters, which may include any one of the image capture parameters described herein, of the first still image with those of the second still image. The adjustment may, in some examples, comprises reference picture resampling. Such adjustment may lead to more accurate inter-view prediction encoding of the second still image using a reference picture comprising the first still image. An unadjusted first still image, optionally an unadjusted second still image, may be encoded and stored for viewing in their original encoded and unadjusted format such that in examples wherein the first still image is of higher image capture quality than a video capture quality of the first video, and optional examples in which the second still image is of higher image capture quality than a video capture quality of the second video, the higher quality images may be maintained for viewing independently of the corresponding encoded video.

In some examples, an image capture device, such as an image capture device of a multi-view imaging assembly may capture the first video using one or more first video capture parameters. A different image capture device, such as within the multi-view imaging assembly, may capture the second video using one or more second video capture parameters different to the first video capture parameters. The first and second video capture parameters may be any suitable video capture parameters, for example: a focal length; an aperture size; a sensor size; a resolution; a zoom type; a lens type; an image stabilization; a shutter speed; an ISO sensitivity; a focus system; a field of view; a depth of field; a resolution; a frame rate; a frame density; a dynamic range; a color gamut.

In some examples, the video encoding may further comprise generating the reference frame. The generating of the reference frame may comprise decoding the first still image. In examples wherein the image data comprises a second still image, generating the reference frame may comprise decoding the encoded second still image. The generating of the reference frame may further comprise adjusting the decoded first still image. In examples wherein the image data comprises a second still image, generating the reference frame may comprise adjusting the decoded second still image. Said adjusting of at least one of the first still image or the second still image may comprise any suitable adjustment, such as for example one or more selected from: spatial alignment; cropping; scaling; resampling; color correction; color matching. At least one of the first still image or the second still image may be adjusted such that a visual parameter of at least one of the first still image or the second still image, which may include one or more of the image capture parameters discussed herein, is aligned with a corresponding visual parameter of at least one of the first video or the second video, which may include one or more of the video capture parameters discussed herein. By way of example, in some cases wherein the first still image is captured at 48 MP image capture resolution, the second still image is captured at 12 MP image capture resolution and the first and second video are each captured at 1080p video capture resolution, the first and second still images may be cropped, scaled and resampled such that the first and second still images are adjusted to 1080p resolution. Said adjustment may improve the accuracy of inter-prediction encoding of frames of the first and second video when using reference frames for the video encoding which comprise at least one of the adjusted first still image or the adjusted second still image.

In some examples, said adjusting is based on a video frame being encoded from at least one of: the first video; or the second video. In such examples, said adjusting may be performed before encoding each said video frame to be encoded, and said adjusting may be different for each said video frame to be encoded. In such examples, said adjusting may comprise identifying a matched feature between: at least one of: the first still image; or the second still image; and the video frame being encoded. In some such examples, said adjusting may comprise adjusting at least one of: the decoded first still image; or the decoded second still image, such that the generated reference frame comprises the matched feature. In some examples the first still image may comprise a wider field of view, a wider viewing angle or a larger scale than video frames of the corresponding first video, and as such contextual information may be present proximate the edges of the first still image which may provide for improved inter-prediction encoding of video frames of the first video. For example, video frames of the first video may represent the movement of a ball across the field of view of the image capture device capturing the first video. The first still image, having a wider field of view than the first video, depicts the ball proximate an edge of the field of the view thereof, prior to the ball becoming visible in corresponding video frames of the first video. Adjustment of the first still image ahead of inter-prediction encoding of the video frames depicting movement of the ball may comprise feature matching the ball in the edge portions of the first still image, such that the edge portions of the first still image are retained in the adjusted first still image, and such that said edge portions may consequently contribute to the video encoding of the corresponding video frames of the first video depicting the ball, for example by aiding the generation of motion vectors for portions of the first still image representing the ball. Such an adjustment of the first still image, informed by the greater field of view of the first still image when compared with the field of view of the first video, may in such examples result in a more accurate video encoding of the first video and a resulting reduction in visual artefacts upon decoding the first video for viewing. Said adjustment may be performed on either the first still image, the second still image, or both, depending on the application of the system or method, and depending on the video frame of the corresponding first or second video to be encoded.

In some examples, the first video and the first still image may share a common first perspective. In some examples, the second video and the second still image may share a common second perspective. It will be appreciated that the first still image and the first video may be captured by the same image sensor, and the second still image and the second video may be captured by the same image sensor. In some examples, generating the reference frame further comprises forming a stereoscopic still image from the first still image (which may in some examples be the decoded and adjusted first still image) and second still image (which may in some examples be the decoded and adjusted second still image). In some examples, the image encoding may comprise image encoding the stereoscopic still image. The encoded stereoscopic still image may be stored for decoding and viewing. In some examples, the stereoscopic image may be encoded and stored such that the stereoscopic image may be decoded for viewing as the stereoscopic image for a three-dimensional viewing experience, or as one of the first or second still images for a flat-screen viewing experience.

In some examples, the video encoding may further comprise generating video frames to be encoded. Said generating may comprise adjusting frames of at least one of: the first video; or the second video, said adjusting using one or more selected from: spatial alignment; cropping; scaling; registration; resampling; frame rate adjustment; aspect ratio adjustment; letter-boxing; pillar-boxing. In examples wherein the first video and the second video are captured using different video capture parameters, the first video and the second video may for example be captured at different sizes, scales, resolutions, field of view or frame rate. In such examples, at least one of the first video or the second video may be required to be adjusted in order for the first video to be used as part of a stereoscopic viewing experience with the second video. Any suitable adjustment will be appreciated which aligns one or more visual parameters, which may include any one of the video capture parameters described herein, of the first video with those of the second video. The adjustment may, in some examples, comprises reference picture resampling. In some examples, the adjustment may comprise replacing a video frame of the first video captured at a same time instance as the first still image with the first still image for the video encoding, and replacing a video frame of the second video captured at a same time instance as the second still image with the second still image for the video encoding. The video frames of the first and second videos captured at substantially the same time instance as the corresponding first or second still image may therefore be excluded from the video encoding process. Excluding the video frames of the first and second videos captured at substantially the same time instance as the corresponding time instance of the first and second still image (and replacing said video frames with the corresponding first or second still image as a reference frame), as a part of the video encoding, may act as a data reduction step reducing the computation required in video encoding and also the resultant memory required for storage. It will be understood that said exclusion and replacement may or may not comprise deleting said video frame. In examples wherein it is desired for the video frame to be available for viewing, said replacement may not comprise deleting the video frame.

In some examples, generating the video frames to be encoded further comprises forming a stereoscopic video from the first video (which may in some examples be the adjusted first video) and second video (which may in some examples be the adjusted second video). In some examples, the video encoding may comprise video encoding the stereoscopic video. The encoded stereoscopic still image may be stored for decoding and viewing. In some examples, the stereoscopic video may be encoded and stored such that the stereoscopic video may be decoded for viewing as the stereoscopic video for a three-dimensional viewing experience, or as one of the first or second videos for a flat-screen viewing experience.

In some examples, the video encoding may further comprise resampling the reference frame, such that the resampled reference frame comprises a resolution matching a resolution of the video frames to be video encoded. Said video encoding may further comprise video encoding the video frames to be video encoded using the resampled reference frame. The methods and systems described herein may therefore in some examples perform reference frame resampling, or reference picture resampling, of a reference frame generated from a decoded still image which was encoded using an image codec. The generated reference frame is resampled for use in encoding video frames of a video using a video codec. The presently described methods and systems may in some examples thereby leverage reference frame resampling across different codecs to improve memory efficiency of concurrently captured image and video.

In some examples, the video encoding may further comprise encoding the video frames to be encoded via inter-prediction using the reference frame in a reverse display order from a time instance of the reference frame; and encoding the video frames to be encoded via inter-prediction using the reference frame in a forward display order from a time instance of the reference frame. In some examples, a time instance of capture of the first still image may be proximate the center of the capture duration of the first video. In some examples, a time instance of capture of the second still image may be proximate the center of the capture duration of the second video. In such examples, video encoding the video frames of the first video and the second video can comprise: inter-prediction encoding video frames captured before the time instance of the first and second still images in a reverse display order based on the reference frame (which comprises at least one of the decoded first still image or the decoded second still image) and inter-prediction encoding video frames captured after the time instance of the first and second still images in a forward display order based on the reference frame. Maximising a proximity of the time instance of at least one of the first still image or the second still image to the center of the capture duration of at least one of the corresponding first video or the corresponding second video, may result in reduced incidence of visual artifacts in encoded video frames in the reverse display order and the forward display order relevant to the time instance of at least one of the first still image or the second still image. In some examples, the capture duration is preferably less than or equal to 5 seconds, and preferably less than or equal to 3 seconds. In some such examples, the capture duration preceding and following the time instance of at least one of the first still image or the second still image is substantially the same. In some such examples the time instance of at least one of the first still image or the second still image is preferably less than or equal to 2.5 seconds and is preferably less than or equal to 1.5 seconds.

In some examples, the video encoding of the disclosed methods and systems may employ any suitable combination of predicted (P) frames and bidirectional predicted (B) frames. P-frames and B-frames are example inter-coded frames. During the encoding and decoding process, inter-coded frames may be encoded and decoded along with intra-coded (I) frames (e.g., as part of a group of pictures or GOP). Without wishing to be bound by theory, an I-frame is a self-contained frame that is encoded independently without referencing any other frames. An I-frame contains all the information needed to decode and display the I-frame. An I-frame may be encoded using intra-frame coding, which is a data compression technique used within a single video frame, enabling smaller file sizes and lower bitrates. By comparison, inter-coded frames, for example P-frames and B-frames, use temporal prediction and compensation by encoding only the differences between frames, exploiting temporal redundancy. Inter-coded frames rely on one or more reference frames to encode the differences between the given inter-coded frame, for example a P-frame or B-frame and the reference frame(s). P-frames depend on previous reference frames (which may be I-frames or P-frames), while B-frames may depend on both previous and next reference frames (which may be any type of frame).

In any event, the first (and optionally second) video in accordance with the present disclosure comprises no I-frames, and therefore the “I” in reference to I:P:B ratios when discussed herein refers to the reference frame comprising at least one of the first still image or the second still image as a surrogate I-frame for the video encoding of the first video, and in examples comprising a second video, video encoding of the second video. By selecting the ratio of P-frames and B-frames relative to the single reference frame comprising at least one of the first still image or the second still image, the present disclosure may achieve bit-rate savings without compromising the quality of the encoded first (and optionally second) video. P-frames may provide a prediction of pixel values from previous frames, while B-frames may provide a prediction from both previous and following frames, thereby offering greater compression efficiency than P-frames. As such, the video encoding in some examples may utilize an I:P:B ratio having a number of B-frames greater than a number of P-frames. In some examples the number of B-frames may be greater than or equal to 5 times the number of P-frames, and may be greater than or equal to 7 times the number of P-frames, and may be greater than or equal to 10 times the number of P-frames. An optimization of I:P:B ratios may lead to a more efficient use of storage space and bandwidth, which is particularly advantageous for devices with limited resources or for applications where data transmission costs are a concern. Any suitable I:P:B ratio may be selected in accordance with a chosen application of the present systems or methods.

It will be appreciated that any process steps and functionality of the present disclosure, in any suitable combination thereof, may be performed on a user device or at a sever. The performance of steps or functionality at a server may in some cases act to conserve memory and computational processing resources on a user device.

It will be appreciated that any features described herein as being suitable for incorporation into one or more examples of the present disclosure are intended to be generalizable across any and all examples of the present disclosure.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1A shows a flow diagram depicting operation of an example system, according to aspects of the present disclosure;

FIG. 1B illustrates a rear view of the example system of FIG. 1A, taking the form of a smartphone equipped with a multi-view imaging assembly;

FIG. 1C depicts a block diagram of the smartphone system, highlighting the control circuitry and its components, according to aspects of the present disclosure;

FIG. 2 presents a flow-chart of method steps for capturing and encoding a multi-media capture technology comprising a concurrently captured image and video, according to aspects of the present disclosure;

FIG. 3 shows a flow diagram of the process steps for capturing, aligning, cropping, and scaling images to create stereoscopic views, according to aspects of the present disclosure;

FIG. 4 depicts a flow-chart of method steps for capturing and encoding a multi-media capture technology comprising a concurrently captured image and video, with a focus on the handling of two different cameras, according to aspects of the present disclosure;

FIG. 5 illustrates a flow diagram of the proposed method for encoding a multi-media capture technology comprising a concurrently captured image and video, emphasizing the use of a single intra-coded picture, according to aspects of the present disclosure;

FIG. 6 shows an example of the adjustment process for matching the content and resolution of images captured by two different cameras, according to aspects of the present disclosure;

FIG. 7 presents an example of using a stereoscopic still image as a reference frame for encoding a stereoscopic video, according to aspects of the present disclosure;

FIG. 8 depicts an encoded video frame sequence structure, highlighting the inter-prediction encoding process, according to aspects of the present disclosure;

FIG. 9 depicts a method of providing concurrent video and image capture in accordance with the present disclosure, emphasizing the use of a still image as a reference frame for inter-prediction encoding of video frames; and

FIG. 10 presents a flowchart of an encoding process for handling still images and videos, according to aspects of the present disclosure.

### DETAILED DESCRIPTION

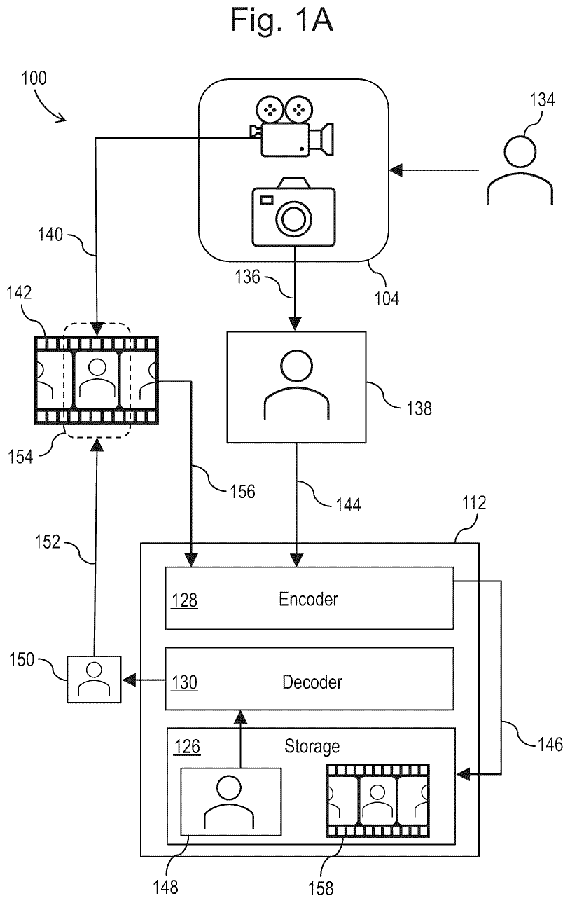

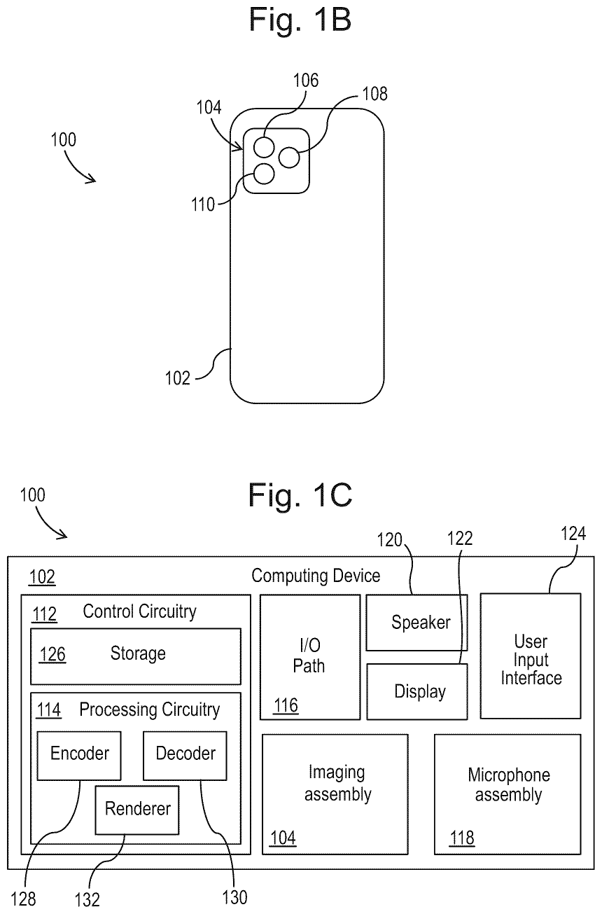

FIG. 1A depicts operation of an example system 100 in accordance with the present disclosure. The example system 100 shown, comprises an imaging assembly 104 comprising an image sensor configured to capture image data in the form of a still image 138 and a video 142 of a subject 134. The system further comprises control circuitry 112 comprising an encoder 128, a decoder 130 and memory storage 126. In the example shown, the still image 138 and the video 142 of the subject 134 are both captured 136, 142 by the image sensor of the imaging assembly 104. The still image 138 and the video 142 are captured 136, 142 concurrently, such that the still image 138 is captured at a time instance occurring during a capture duration of the video 142. The captured still image 138 is image encoded 144 by the encoder 128 using an image codec, for storage 146 as an encoded still image 148 in the memory 126. The encoded still image 148 is decoded by the decoder 130 and the decoded still image 150 is adjusted 152 for use as a reference frame 154 for video encoding 156 video frames of the video 142 by the encoder 128 using a video codec. The encoded video 158 is then stored 146 in the memory 126.

FIG. 1B depicts an example system suitable for performing the process depicted in FIG. 1A, and in the example shown in FIG. 1B a smartphone system 100, with the rear view thereof depicted in FIG. 1B. The smartphone 102 is equipped with a multi-view imaging assembly 104, which comprises three spatially arranged cameras each having different corresponding image capture parameters and video capture parameters. Any suitable arrangement of cameras for a multi-view imaging assembly will be appreciated, and in the specific example shown, the multi-view image assembly 104 includes a main wide-angle camera 106, an ultra wide-angle camera 108, and a telephoto lens camera 110. The main wide-angle camera 106 has a 48 MP quad pixel image sensor specification and a 24-48 mm focal length, the ultra wide-angle camera 108 comprises a 12 MP image sensor specification and a 0.5-13 mm focal length, and the telephoto lens camera 110 comprises a 1 MP image sensor specification and a 36-77 mm focal length. The multi-view imaging assembly 104 is disposed proximate the top portion of the smartphone 102, with the three cameras 106, 108, 110 spatially arranged in a triangle configuration. In the example shown, the main wide-angle camera 106 is located at an uppermost portion of the assembly 104 vertically above the telephoto lens camera 110 at a lowermost portion of the assembly 104, the main wide-angle camera 106 and the telephoto lens camera 110 together forming a vertical base of the triangle arrangement. The ultra wide-angle camera 108 is positioned on a plane between the main wide-angle camera 106 and the telephoto lens camera 110 and offset to the right of the vertical base, forming the third vertex of the triangle arrangement. The example arrangement shown may enable a particular range of photographic capabilities, and any suitable further arrangements having any number of cameras will be appreciated.

The example system 100 of FIG. 1B is further shown in FIG. 1C in the form of a block diagram. The example system 100 comprises a computing device 102, which in the example discussed is a smart-phone 102. It will be appreciated that the computing device 102 may be any suitable device such as an extended reality device for example comprising a HMD, a personal computer, a laptop computer, a tablet computer, a smartphone, a smart television, a smart speaker, or any other type of computing device, and includes the multi-view imaging assembly 104 shown in FIG. 1B. The device 102 further comprises control circuitry 112 having processing circuitry 114, I/O path 116, microphone assembly 118, speaker 120, display 122, and user input interface 124, which in some examples provides a user selectable option for capturing still images and videos by way of the multi-view imaging assembly 104 and viewing the captured still images and videos. Control circuitry 112 includes storage 126 and processing circuitry 114. Processing circuitry 114 comprises an encoder 128, a decoder 130 and a renderer 132. Control circuitry 112 may be based on any suitable processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

The storage 126, which may additionally, or alternatively, include storages of other components of system 100, may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid-state devices, quantum storage devices, gaming consoles, gaming media, or any other suitable fixed or removable storage devices, or any combination of the same. The storage 126, which may additionally, or alternatively, include storages of other components of system 100 may be used to store various types of content, metadata, and or other types of data. Non-volatile memory may also be used (e.g., to launch a boot-up routine and other instructions). Cloud-based processing and storage may be used to supplement processing circuitry 114 and storage 126. In some examples, control circuitry 112 executes instructions for an application stored in memory (e.g., storage 126). Specifically, control circuitry 112 may be instructed by the application to perform the functions discussed herein. In some implementations, any action performed by control circuitry 112 may be based on instructions received from the application. For example, the application may be implemented as software or a set of executable instructions that may be stored in storage 126 and executed by control circuitry 112. In some examples, the application may be a client/server application where only a client application resides on computing device 102, and a server application resides on a remote cloud server.

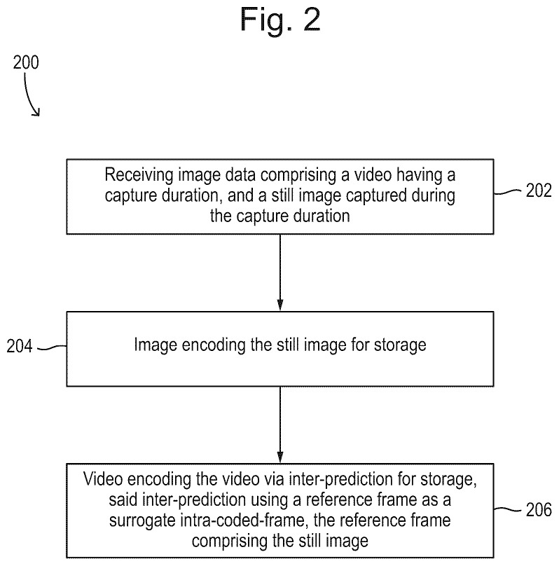

FIG. 2 depicts a flow-chart of method steps of an example method 200 in accordance with the present disclosure. In particular, the method comprises: receiving image data comprising a video having a capture duration, and a still image captured during the capture duration 202; image encoding the still image for storage 204; and video encoding the video via inter-prediction for storage, said inter-prediction using a reference frame as a surrogate I-frame, the reference frame comprising the video encoding the video using the still image as a reference frame 206.

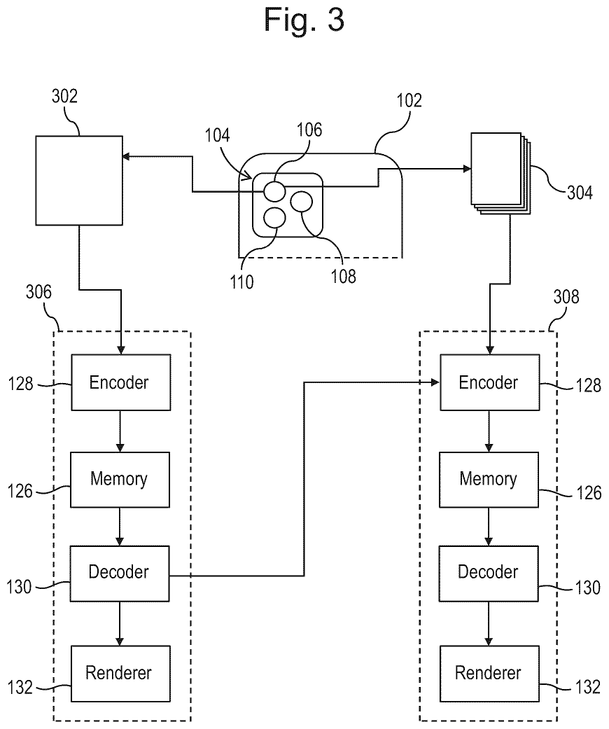

FIG. 3 shows a flow diagram depicting in more detail process steps of an example method in accordance with the present disclosure, suitable for performance with a smart-phone 102 as shown and described in relation to FIG. 1A to 1C, and in a method 200 as shown and described in relation to FIG. 2. As shown in FIG. 3, a single camera of the multi-view imaging assembly 104 of the smart-phone 102 is used to capture a still image 302 and a video 304 comprising a plurality of video frames captured at a frame rate over a capture duration. In the example shown, the still image 302 and the video 304 are captured using the main wide-angle camera 106 of the multi-view imaging assembly 104, but examples will be appreciated wherein any camera 106, 108, 110 of the multi-view imaging assembly 104 is used. In the example shown, the still image 302 and the video 304 are captured by the single image sensor (not shown) of the camera 106 concurrently such that the still image 302 is captured and stored during the capture duration of the captured video 304.

In the particular example shown, the video 304 is a short video having video frames captured at the frame rate over a three-second capture duration. In the example shown, the still image 302 is captured at a time instance located precisely in the center of the capture duration, such that the video 304 comprises video frames spanning 1.5 seconds of the capture duration captured immediately before the time instance of the still image 302 capture, and video frames spanning the remaining 1.5 seconds of the video 304 capture duration immediately after the time instance of the still image 302 capture.

In the particular example shown, the capture of video frames by the main wide-angle camera 106 and storage of said captured video frames on the memory 126 of smart phone 102 is initiated at a capture time instance upon the receipt of a user input at a user input interface 124 of the smart-phone 102, said input causing a camera application to be executed by the processing circuitry 114 of the smart phone 102. In the particular example shown, said captured video frames which were captured earlier than a pre-capture period of 1.5 second are deleted from the memory 126 such that, while the camera application remains executed on the smart phone 102, the memory 126 stores video frames having the pre-capture duration of 1.5 seconds preceding a capture time instance. Upon receipt of a corresponding capture input at the user input interface 124 at a capture time instance, the camera application is caused to instruct capture and storage of the still image 302 at the capture time instance of the capture input. Upon detecting the capture input, said deletion of video frames outside of the pre-capture period is ceased, and capture and storage of video frames for a post-capture period of 1.5 seconds following the capture time instance is initiated. The video frames of the 1.5 second pre-capture period and the 1.5 second post capture period are stored as the 3 second video 304 alongside the still image 302 as part of associated image data. The temporal positioning of the still image 302 at the immediate end of the pre-capture period and at the immediate beginning of the post-capture period positions the still image 302 precisely at the center of the capture duration of the video 304. Any suitable method of capturing a still image during a capture of a video will be appreciated.

In the example shown, following capture at the capture time instance, the still image 302 is encoded by the encoder 128 of the smart-phone 102 using an image codec 306, before the encoded still image is stored in the memory storage 126 of the smart-phone 102. Any suitable image codec may be used, with a list of some possible examples comprising: Joint Photographic Experts Group (JPEG); JPEG 2000 (JP2); Portable Network Graphics (PNG); Graphics Interchange Format (GIF); Web Picture format (WebP); High Efficiency Image Format (HEIF); Tagged Image File Format (TIFF); Bitmap (BMP); Raw Image Format (RAW); Free Lossless Image Format (FLIF). The particular codec used may depend on a required compatibility, for example with stereoscopic image capture, encoding/decoding and viewing. The encoded still image is subsequently decoded for use as a reference frame for video encoding the video 304, the reference frame suitable for use in inter-prediction encoding of the frames of the video 304. Following decoding, the decoded still image is therefore then used as the reference frame for inter-prediction encoding of frames of the video 304 using the encoder 128 of the smart-phone 102 by way of a video codec 308. The inter-prediction encoded video is stored in the memory storage 126 of the smart-phone 102. Any suitable video codec may be used, with a list of some possible examples comprising: Advanced Video Coding (AVC/H.264); High Efficiency Video Coding (HEVC/H.265); MPEG-1 (Moving Picture Experts Group 1); MPEG-2 (Moving Picture Experts Group 2); MPEG-4 Part 2 (MPEG-4); VP8 (Video Processing 8); VP9 (Video Processing 9); AVI (AOMedia Video 1); Theora (Theora); QuickTime File Format (QTFF); Windows Media Video (WMV); DivX (Digital Video Express); Xvid; RealVideo (RV); ProRes (Apple™ ProRes); DNxHD (Digital Nonlinear Extensible High Definition). The particular codec used may depend on a required compatibility, for example with stereoscopic video capture, encoding/decoding and viewing. The encoded still image and the encoded video may then be decoded by the decoder 130 of the smart-phone 102 prior to rendering by the renderer 132 of the smart-phone 102 for viewing by a user, following a corresponding input at the user input interface 124.

In accordance with the example described in FIG. 3, the display 122 of the smart phone 102 may be caused, in accordance with a corresponding input, to display the decoded still image or the decoded video independently, or may in some instances be caused to display the decoded video and the decoded still image simultaneously, wherein the decoded still image forms a video frame of the decoded video to be played at the relative temporal position of the still image within a display duration of the video.

In the particular example shown in FIG. 3, video frames of the video 304 captured during the pre-capture period are inter-prediction encoded in a reverse display order from the temporal positioning of the still image 302, said inter-prediction encoding generating predicted frames using the reference frame as a surrogate I-frame. Video frames of the video 304 captured during the post-capture period are also inter-prediction encoded in a forward display order from the temporal positioning of the still image 302, said inter-prediction encoding generating predicted frames using the reference frame as a surrogate I-frame. The inter-prediction encoding of the video frames therefore does not include the independent encoding of an intra-coded video frame, and instead uses the decoded still image as a surrogate I-frame. The central temporal positioning of the still image 302 in the capture duration of the video 304 in the example shown aids the use of the still image 302 as a single intra-coded reference frame. The short capture duration, such as of 3 seconds in the example shown, negates the generation of any further I-frames from video frames of the video 304, thereby permitting complete video encoding of the video frames of the video without the separate intra-frame encoding. The comparative processing and memory cost of generating an intra-coded video frame from one or more video frames of the video, when compared with the lower processing and memory cost of generating predicted frames, may therefore be avoided.

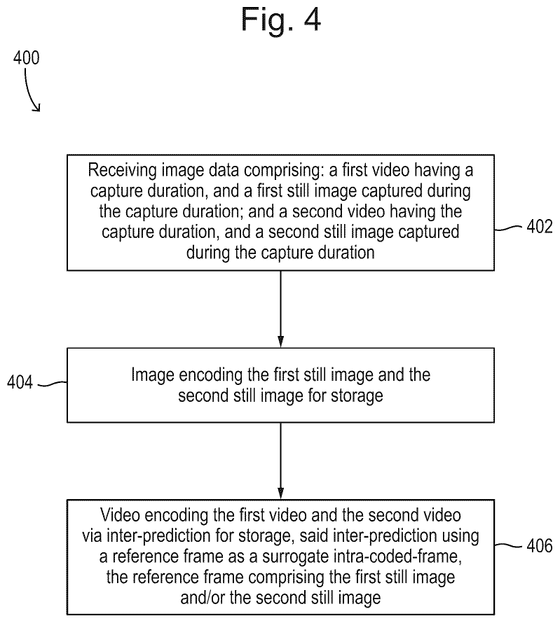

FIG. 4 depicts a flow-chart of method steps of an example method 400 in accordance with the present disclosure. The example method 400 depicted is largely in accordance with the method 200 described and depicted in relation to FIG. 2. In the alternate example method 400 of FIG. 4, the method comprises: receiving image data comprising: a first video having a capture duration, and a first still image captured during the capture duration; and a second video having the capture duration, and a second still image captured during the receiving a first video and a first still image, and receiving a second video and a second still image 402; image encoding the first still image and the second still image for storage 404; and video encoding the first video and the second video via inter-prediction for storage, said inter-prediction using a reference frame as a surrogate I-frame, the reference frame comprising the video encoding the first and second video using at least one of the first still image or the second still image as a reference frame 406.

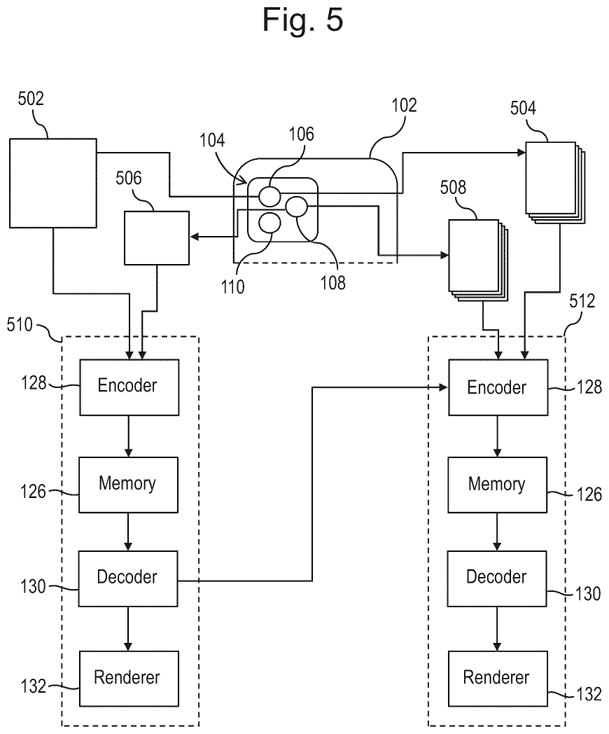

FIG. 5 shows a flow diagram depicting an example method in accordance with the present disclosure, suitable for performance with a smart-phone 102 as shown and described in relation to FIG. 1A to 1C, and in a method 400 as shown and described in relation to FIG. 4. The example method depicted in FIG. 5 is largely in accordance with the example method depicted in FIG. 3. As shown in FIG. 5, two cameras of the multi-view imaging assembly 104 of the smart-phone 102 are used to capture a corresponding still image 502, 506 and a corresponding video 504, 508. In the example shown, a first still image 502 and a first video 504 are captured using the main wide-angle camera 106 of the multi-view imaging assembly 104, and a second still image 506 and a second video 508 are captured using the ultra wide-angle camera 108 of the multi-view imaging assembly 104. Examples will be appreciated wherein any suitable combination of cameras 106, 108, 110 of the multi-view imaging assembly 104 is used. In the example shown, the first still image 502 and the first video 504 are captured by the single image sensor (not shown) of the main wide-angle camera 106 concurrently such that the first still image 502 is captured and stored during a duration of the captured first video 504. In the particular example shown, the first video 504 is a short video having a 3 second capture duration. In the example shown, the first still image 502 is captured precisely in the center of the capture duration, such that the first video 504 comprises 1.5 seconds of the capture duration captured immediately before a time instance of the first still image 502 capture, and the remaining 1.5 seconds of the first video 504 capture duration immediately after the time instance of the first still image 502 capture. The second still image 506 and the second video 508 are captured by the single image sensor (not shown) of the ultra wide-angle camera 108 concurrently such that the second still image 506 is captured and stored during a duration of the captured second video 508. In the particular example shown, the second still image 506 is captured at the same time instance as that of the first still image 502, and the second video 508 is captured during the same capture duration as the first video 504.

In the particular example shown, the first still image 502 and the first video 504 share a common first perspective and the second still image 506 and the second video 508 share a second common perspective. The first and second perspectives in the example shown are stereoscopic views such that the first and second still image 502, 506 may together be configured to form a stereoscopic still image pair, and the first video 504 and the second video 508 may together be configured to form a stereoscopic video. Examples will be appreciated wherein the stereoscopic still image is image encoded, and wherein the decoded stereoscopic still image is used as part of a reference frame for inter-prediction encoding of video frames of the stereoscopic video.

In the example shown, the first still image 502 and the second still image 506 are encoded by the encoder 128 of the smart-phone 102 using an image codec 510. In the example shown, the second still image 506 is encoded using inter-view prediction using the first still image 502 as a reference picture. Examples will be appreciated wherein the second still image 506 may be encoded independently of the first still image 502. The encoded first and second still images 502, 506 are stored in the memory storage 126 of the smart-phone 102. The encoded first and second still images are subsequently each decoded for use as a corresponding reference frame, each corresponding reference frame suitable for use in inter-prediction encoding video frames of the respective first and second video 504, 508. The decoded first and second still images are therefore each then used as the corresponding reference frame for inter-prediction encoding of video frames of the respective first and second video 504, 508 using the encoder 128 of the smart-phone 102 by way of a video codec 512. The inter-prediction encoded first and second videos are stored in the memory storage 126 of the smart-phone 102. The encoded first and second still images and the encoded first and second videos may then be decoded by the decoder 130 of the smart-phone 102 prior to rendering by the renderer 132 of the smart-phone 102 for viewing by a user. Examples will be appreciated wherein the video frames of the second video are video encoded using, at least in part, inter-view prediction encoding using corresponding video frames of the first video as a reference frame.

The example method depicted in FIG. 5 incorporates pre-capture and post-capture period video frame recording functionalities, in accordance with those discussed herein in relation to FIG. 3. This functionality may enhance a user experience by capturing moments immediately before and immediately after an actual point of image capture, and may ensure that a user does not miss any pertinent action or expression occurring immediately before they engage with the capture input.

In the particular example described, for the first video 504, the pre-capture period comprises video frames captured during the 1.5 seconds immediately preceding the capture of the first still image 502. Similarly, the post-capture period includes video frames recorded in the 1.5 seconds following the capture of the first still image 502. This results in a total capture duration of 3 seconds for the first video 504, with the first still image 502 being captured at the precise midpoint of this duration in the manner described in relation to FIG. 3.

The second video 508 follows the same capture and storage process, with the pre-capture and post-capture periods aligned with those of the first video 504. The second still image 506 is captured simultaneously with the first still image 502, such that both the first and second still images 502, 506 capture the same moment in time from their respective camera perspectives.

The pre-capture and post-capture feature may aid in generating video that captures the essence of a moment, providing a richer context to the corresponding still images. Such capture may allow for the generation of a video sequence that includes the lead-up to and the aftermath of the captured still images, offering a more complete and engaging user experience.

In the context of the smart-phone 102, the control circuitry 112, upon receiving a user input to execute an image capture application, such as camera application, on the smart phone 102, initiates the recording of the pre-capture video frames using each of the two cameras 106, 108. Upon detecting the image capture input, the system captures the first and second still image and continues to record the post-capture video frames of the corresponding first and second videos. The system then encodes the still images and videos as previously described, utilizing the first and second still images as reference frames for the inter-prediction encoding of the video frames of the first and second videos.

The pre-capture and post-capture periods may be seamlessly integrated into the capture process, which may be of particular utility for dynamic scenes where actions or expressions are fleeting, and capturing the desired moment may be challenging.

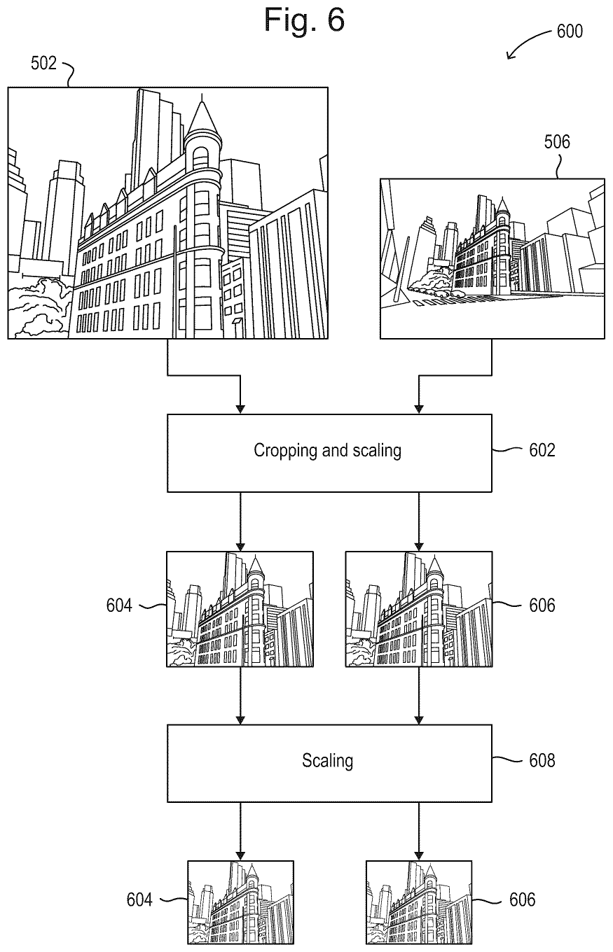

FIG. 6 depicts steps of an example adjustment process 600 for use in systems and methods of the present disclosure, such as the method depicted and described in relation to FIGS. 4 and 5. The first still image 502 and the second still image 506 are captured substantially simultaneously using corresponding cameras of a multi-view imaging assembly 104 such as that described in relation to FIG. 4 and FIG. 5. In the example shown, the first still image 502 is captured in 48 MP using the main wide-angle camera 106 of the multi-view imaging assembly 104 and the second still image 506 is captured in 12 MP using the ultra wide-angle camera 108 of the multi-view imaging assembly 104. The field of view of the ultra wide-angle camera 108 is larger than the field of view of the main wide-angle camera 106 such that the second still image 506 comprises image content which is outside of the view of the first still image 502. The first still image 502 is captured at a higher resolution than the second still image 506. In order to be used as part of a stereoscopic image, the first still image 502 and the second still image 506 in the adjustment process 600 shown are each cropped, scaled 602 or any combination of both (which may also include resampling) such that the dimensions and visual parameters of the first and second still images 502, 506 are substantially same, and that the first and second still images 502, 506 comprise image content providing respective views 604, 606 of a stereoscopic still image. In order for the respective views 604, 606 to be used as corresponding reference frames for encoding the first and second video 504, 508 in accordance with the present systems and methods, the respective views 604, 606 are further scaled 608 to match the aspect ratio and resolution (16:9; 1080p) of the captured first and second video 504, 508.

Examples will be appreciated wherein the adjustment of the first and second still images to achieve respective views of a stereoscopic image may involve any suitable combination of image adjustment techniques beyond registration, cropping, scaling and resampling, such as those discussed herein. Such techniques may be employed to accommodate differences in any suitable image capture parameters between the first and second still images, such as differences in one or more selected from: focal length, aperture size, sensor size, resolution, zoom type, lens type, image stabilization, shutter speed, ISO sensitivity, focus system, field of view, depth of field, dynamic range, and color gamut, among any other suitable image capture parameter.

For example, spatial alignment may be performed to ensure that the first and second still images are aligned in such a way that the corresponding points in a scene are positioned correctly relative to each other for rendering and viewing stereoscopically. This may involve adjusting the orientation and position of the images, or portions thereof, to correct for any angular discrepancies or shifts that occurred during image capture, for example due to the different camera positions or orientations. Color correction may be applied to ensure color consistency between the first and second still images. Since different cameras or lenses may have varying color responses, color correction may aid in matching color tones and white balance, providing a more uniform appearance in the stereoscopic image. Geometric distortion correction may be used to rectify any lens-induced distortions such as barrel or pincushion distortion. This may be particularly relevant when the two cameras have different lens types or focal lengths, which may in some cases cause variations in the geometric representation of a scene. Focus matching may be performed if the depth of field or focus system differs between the two cameras. This ensures that areas of interest within the first and second still images have similar levels of sharpness, which may contribute to a cohesive stereoscopic effect. Exposure adjustment may be carried out to match the brightness levels between the first and second still images. Differences in sensor sensitivity, shutter speed, or aperture size may result in varying exposure levels, which may be harmonized through said exposure adjustment. Dynamic range alignment may be considered if the image sensors of the two cameras each have different dynamic range capabilities. Appropriate image adjustment may involve adjusting the contrast and brightness of the first and second still images to ensure that both images have a similar range of tones, from the darkest shadows to the brightest highlights. In some examples, keystone correction may be applied to adjust for any perspective distortions that arise when the two cameras are not perfectly parallel to each other or to a subject plane. Additionally, image warping or morphing techniques may be utilized to modify the shape and structure of the first and second still images such that they align with one another more accurately, which may act to provide a more natural stereoscopic view. In some examples, machine learning or computer vision techniques may be employed to aid the adjustment process, which may comprise analyzing the first and second still images to determine any appropriate transformations and adjustments to achieve the desired stereoscopic effect.

It is to be appreciated that the aforementioned adjustments may be applied individually or in combination, and the specific adjustments may depend on the particular image capture parameters of the first and second still images, as well as a desired outcome for the stereoscopic image. The goal of the adjustments is to create a pair of images which, when viewed together, provide a convincing and comfortable three-dimensional viewing experience without noticeable discrepancies between the two views.

In addition to the adjustments already described, further steps may be taken to ensure that visual parameters of the first and second still images are aligned with the video capture parameters of the corresponding first and second videos. Such further adjustment may improve suitability of the first and second still images for use as part of a corresponding reference frame for encoding video frames of the respective first or second video by way of inter-prediction encoding. It will be appreciated that such further adjustment may be performed in any order in relation to the image adjustment described for aligning the visual parameters of the first and second still images, and may for example be performed before, after, or as part of the earlier image adjustment discussed. Such further adjustment may include any suitable image adjustment techniques such as those described herein and may also include, for example, noise adjustment techniques, which may be applied to the still images to match a noise profile of the corresponding video. Since videos may inherently have more noise due to lower exposure times and higher ISO settings, noise profile adjustment on the first and second still images may help in achieving uniformity with a noise profile of video frames of the corresponding first or second video. In some examples, sharpness and detail enhancement may be considered to ensure that the first and second still images, which may be captured at a higher resolution than video frames of the corresponding first and second video, do not appear overly sharp when compared to the video frames. Such adjustment may involve selectively blurring or softening the first and second still images to match the level of detail of the corresponding video frames. In some examples, aspect ratio conversion may be performed if the first and second still images and the corresponding first and second videos have different aspect ratios. This may ensure that the images fit within the video frame without any stretching or squashing, maintaining the correct proportions of the scene. In some examples. color grading may be applied to the first and second still images such that a color profile thereof matches a color profile and style of the corresponding first and second video. Machine learning or computer vision techniques may also be used to simulate any depth of field effects present in the video frames, ensuring that the background blur in the still images matches the video.

Such further adjustments may be aimed at creating cohesive and consistent reference frames that closely match the visual parameters of the corresponding video frames of the first and second videos. By aligning the visual parameters of the first and second still images with those of the corresponding first and second videos, the encoded video frames may benefit from improved compression efficiency and visual quality, including a reduction of visual artifacts, when the first and second still images are used as part of reference frames for inter-prediction encoding.

The inter-prediction encoding may, for example, be performed using any suitable technique, and may include motion estimation to determine the movement of objects between the reference frame and the video frames, allowing for the efficient prediction of video frame content.

The inter-prediction encoding may, for example, be performed using any suitable technique, and may include motion estimation, which may be conducted by dividing a target video frame of the corresponding first or second video into blocks or macroblocks, which are typically 16×16 pixels in size, though other sizes may also be used. A search area may then be defined in the reference frame (comprising at least one of the first or second still image), usually surrounding a position of the current block or macroblock being encoded. Each said block or macroblock in the target video frame may be compared to blocks or macroblocks within said search area of the reference frame to identify the best match, based on any suitable criteria such as Sum of Absolute Differences (SAD), Sum of Squared Differences (SSD), or any more complex metrics like the Hadamard transform.

Motion vector calculation may be performed, for example by identifying the position of a best matching block in the reference frame and calculating a displacement from the original position in the target video frame as a motion vector. Said motion vector may then be encoded, and may for example be encoded using differential coding relative to neighboring motion vectors, which may look to exploit spatial redundancy and minimize an amount of data in the encoded video frame.

If applicable, reference picture resampling may be conducted to adjust a resolution of the reference frame to match that of the target video frame, and may include up-sampling or down-sampling of the reference frame, for example using interpolation techniques. The reference frame may also be spatially aligned with the target video frame to improve accuracy of motion estimation. Said spatial alignment may, in some examples, be driven by the outcome of said block-matching, which may in some examples inform spatial alignment of the reference frame with the target video frame. The reference frame comprising the first or second still image may comprise a wider field of view image than the target video frame to be encoded. As such, a portion of the image near the edges thereof may comprise visual information which is useful for said motion prediction in particular video frames positioned pre-or post-capture in the capture duration of the video. Said feature matching process may therefore make use of a wider field of view portion of the reference frame in the motion vector calculation as described herein.

Motion compensation may then be used to generate a predicted block for each block in the target video frame, using the calculated motion vectors and corresponding blocks from the reference frame. Said predicted blocks may then be assembled to form a predicted version of the target frame.

A residual may be calculated by subtracting the predicted block from the actual block in the target video frame, the residual representing a prediction error. Such residuals may be transformed using a suitable transformation, for example Discrete Cosine Transform (DCT) or Integer Transform (IT), to convert spatial domain data to frequency domain coefficients, which may then be quantized to reduce the precision of less significant data.

Quantized transform coefficients may then be encoded, for example using entropy coding techniques such as Huffman coding, Arithmetic coding, or Context-Adaptive Binary Arithmetic Coding (CABAC). Additionally, motion vectors and other information, such as block types and quantization parameters, may be entropy encoded.

Reference frame management may involve maintaining a reference frame list from which suitable reference frames may be selected for the inter-prediction of each block. This list can the reference frame comprising at least one of the first still image or the second still image, and may include previously decoded frames. After the encoding of a current video frame to be encoded, the current frame may be added to the reference frame list for use in inter-prediction encoding further video frames.

For B-frames, bidirectional prediction is utilized, in which blocks may be predicted using both previous and subsequent reference frames. Motion estimation and compensation may be performed in both forward and backward directions, and the forward and backward predictions may be combined, such as through weighted averaging, to provide a final predicted block.

Error handling and robustness may also be considered, with techniques such as flexible macroblock ordering, redundant slices, or adaptive intra refresh optionally being employed, such as to enhance error resilience and improve robustness of the encoded first or second video.

Adaptive techniques like rate-distortion optimization (RDO) may be employed to counter any potential trade-offs between compression efficiency and visual quality, selecting the best coding modes and parameters for each block. The encoder may, for example, select from between different coding modes, such as from a range of block sizes, for example based on one or more visual parameters of the reference frame or the video frames to be encoded, or any encoding constraints which may for example be dependent on resource availability.

The inter-prediction encoding process may also comprise selecting an appropriate ratio of P-frames and B-frames. The choice of frame types and the order in which they are encoded may influence the compression efficiency and the quality of the encoded first and second video.

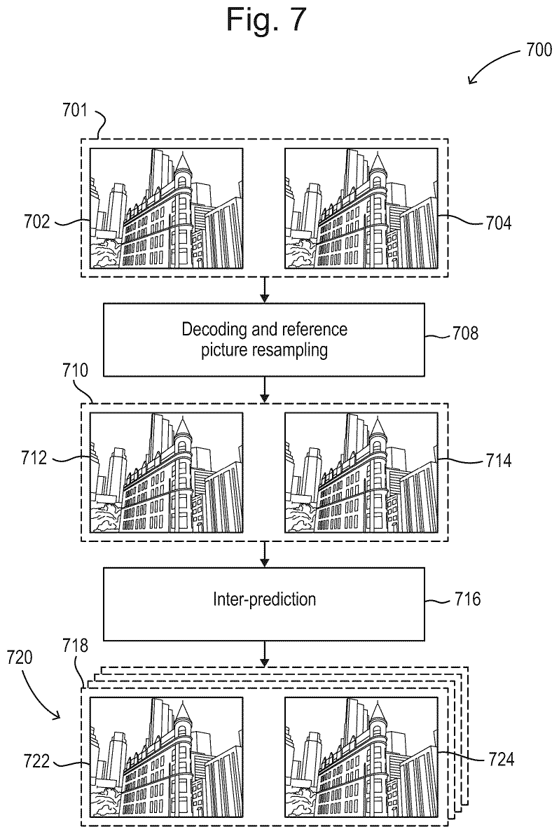

FIG. 7 depicts steps of an example adjustment process 700 for use in systems and methods of the present disclosure, wherein a stereoscopic still image is used as a reference frame for encoding a stereoscopic video. In the example adjustment process 700 shown, a stereoscopic still image 701 comprises a first still image 702 providing a left eye view of the stereoscopic still image and a second still image 704 providing a right eye view of the stereoscopic still image 701. The first and second still images 702, 704 of the example stereoscopic still image pair 701 shown may, for example, be the first and second respective views 604, 606 provided in the example adjustment process 600 shown and described in relation to FIG. 6. In the example adjustment process 700 shown, the stereoscopic still image 701 is decoded and undergoes reference picture resampling 708 to provide a stereoscopic reference frame 710 comprising a resampled first view 712 corresponding to a first video of a stereoscopic video and a resampled second view 714 corresponding to a second video of the stereoscopic video. The stereoscopic reference frame 710 is then used for inter-prediction encoding 716 of video frames 718 of the stereoscopic video 720 comprising the frames of the first video 722 and the frames of the second video 724.

In the example adjustment process 700 depicted in FIG. 7, the stereoscopic still image 701 serves as a foundational element for the subsequent encoding of a stereoscopic video. The stereoscopic still image 701 is composed of a first still image 702 and a second still image 704, which provide the left and right eye views, respectively, of the stereoscopic image. These images may be derived from the first and second respective views 604, 606, as adjusted in the example adjustment process 600.

Upon capturing the first and second still images 702, 704, the images are decoded, which may involve converting the images from a compressed format into a raw format that can be manipulated for further processing. Following this, reference picture resampling 708 is performed on the decoded images to ensure that the resolution and aspect ratio of the stereoscopic reference frame 710 align with the specifications of the video frames to be encoded. This resampling process may involve adjusting the pixel density, resizing the images, or changing the aspect ratio to match the target video format.

In addition to the described reference picture resampling, any other suitable adjustment of the stereoscopic still image may be employed to enhance the alignment and consistency between the stereoscopic still image and video frames of the stereoscopic video. Additionally, or alternatively, the adjustment may comprise any suitable adjustment to align the visual parameters of the two views of the stereoscopic still image, for example in line with those discussed herein in relation to FIG. 6.

Once the stereoscopic reference frame 710 is prepared, it is utilized for the inter-prediction encoding of video frames 718 of the stereoscopic video 720. This encoding process involves using the reference frame 710 to predict the content of the video frames, thereby reducing the amount of data that is stored or transmitted.

The inter-prediction encoding may be performed by any suitable process, for example in line with that discussed herein.

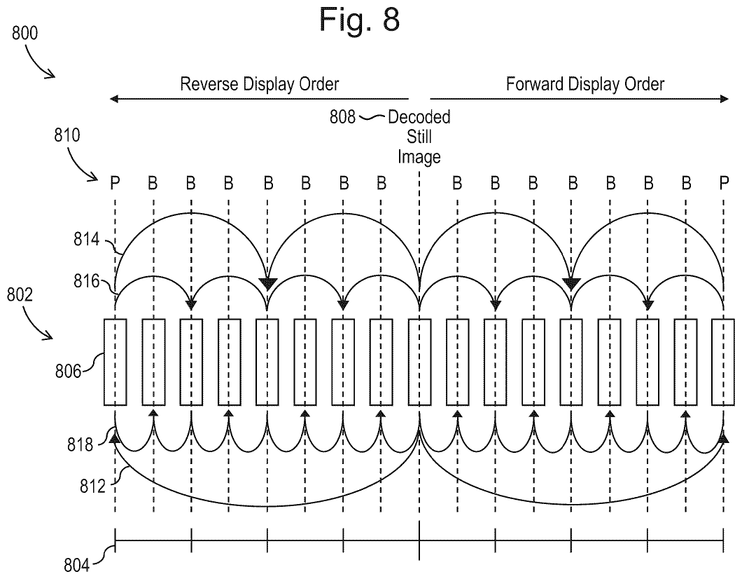

FIG. 8 depicts an encoded video frame sequence structure 800 encoded in accordance with systems and methods described herein. In particular, the video frame sequence structure comprises a sequence of encoded frames 802 for a video captured over a capture duration 804, which in the example depicted is 3 seconds. Each encoded frame 806 of the sequence of frames 802 is generated by way of inter-prediction encoding using any suitable technique, such as those described herein. In the specific example shown, the inter-prediction encoding is performed from a top level reference frame 808 which in accordance with systems and methods described herein is a decoded still image captured concurrently with the video. In the particular example 800 shown, the still image is captured at precisely the center of the capture duration 804 (1.5 seconds into the video capture), therefore providing 1.5 seconds of video frame capture before and after the still image capture. The example structure 800 depicted is encoded from the reference frame 808 in the reverse display order and in the forward display order to provide encoded frames 806 of video before and after the still image capture respectively, in accordance with an I:P:B frame ratio 810, which in the example shown is 1:2:14. First level P frames 812 are generated from the reference frame 808. Second level B frames 814 are then generated from the respective first level P frame and the reference frame 808. Third level B frames 816 are generated from the second level B frames, and the first level P frame or the reference frame. Fourth level B frames 818 are generated from the second level B frames, the third level B frames and the first level P frame or the reference frame. The arrows indicate the prediction dependencies between the frames, with the decoded still image 808 serving as the initial reference frame for the inter-prediction encoding of the video frames in both reverse and forward display orders.

The use of a still image as part of a reference frame as the single surrogate I-frame for encoding video frames in both reverse and forward display orders from the time instance of the still image capture may offer a balance between encoding efficiency, video quality, and computational simplicity. These benefits may be particularly apparent when encoding video frames of a video having a short capture duration, for example less than or equal to 5 seconds, or less than or equal to 3 seconds. In the specific example shown in FIG. 8, the video has a total duration of 3 seconds, with 1.5 seconds of video frames captured before and after the image capture. This short video length may contribute to the efficiency and quality of the encoding process. The limited number of frames may act to reduce the complexity of the encoding task and minimize susceptibility to persisting, or compounding, prediction errors. This approach may be well-suited for modern multi-media capture and viewing applications where increasingly high-quality image and video capture is desired alongside efficient storage and processing requirements.

In the particular example shown in FIG. 8, the video frame occurring at the same time instance within the video capture duration as the still image is removed prior to encoding. Such removal may act as a data reduction step reducing the required processing and memory resources for the encoding and storing of the video.

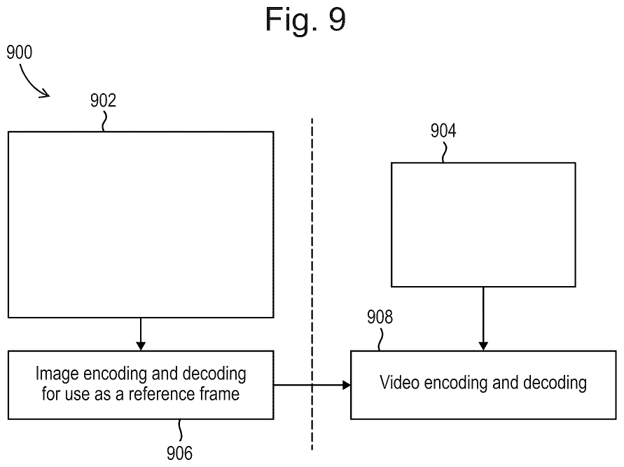

FIG. 9 depicts method 902 of providing concurrent video and image capture in accordance with systems and methods described herein. In particular, the method 900 comprises concurrent capture of one or more still images 902 and one or more corresponding videos 904, image encoding and decoding 906 the one or more still images, for use as a reference frame for inter-prediction encoding 908 of frames of a said video 904. The presently disclosed methods and systems thereby negate the separate encoding and storage of an I-video frame, instead opting to use the still image in a reference frame for inter-prediction encoding the video frames, the reference frame, comprising the still image, thereby serving as a surrogate I-frame for video encoding the video frames.

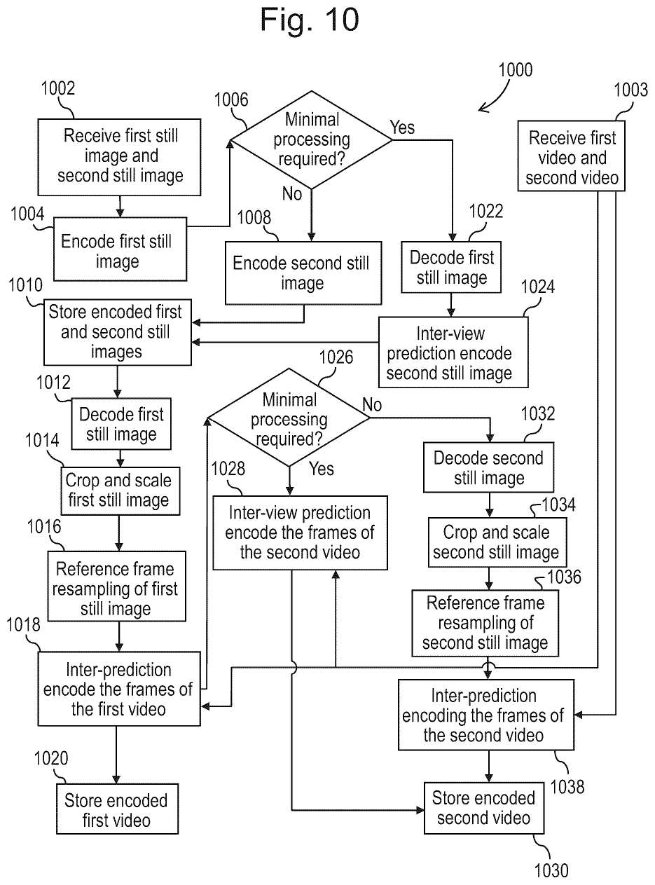

FIG. 10 depicts a flowchart indicating steps of a further example process 1000 comprising additional steps in an encoding process for handling still images and videos, in accordance with methods and systems of the present disclosure, and in addition to the steps described in relation to FIG. 2, FIG. 4 and FIG. 9. The process 1000 begins with the receipt of a first still image and a second still image 1002 and the receipt of a first video and a second video 1003. The first still image and the first video in the example 1000 shown are captured by a single image sensor of a multi-view imaging assembly and the second still image and the second video are captured by a different single image sensor of the multi-view imaging assembly, such that the first still image and the second still image together form component parts of a multi-view stereoscopic image, and the first video and the second video together form component parts of a multi-view stereoscopic video. Receipt of the first and second still images and the receipt of the first and second videos may be via any suitable technique such as those described herein. Following receipt of the first and second still images 1002, the first still image is independently encoded 1004. In examples wherein there are no constraints on processing requirements 1006, the second still image is independently encoded 1008 and the encoded first and second still images are stored 1010. The encoded first still image is accessed from the memory and decoded 1012, and the decoded first still image is cropped and scaled 1014 in accordance with the video capture parameters of the received first and second videos. The cropping and scaling 1014 may be accompanied by any suitable image adjustment such as those discussed herein, and in the specific example 1000 shown, is followed by reference frame resampling to match a resolution of video frames of at least one of the received first video or the received second video, providing a reference frame which is used as a surrogate I-frame for inter-prediction encoding of video frames of the first video 1018. The inter-prediction encoded first video is then stored in the memory 1020. In examples wherein minimal processing is not required 1026, the encoded second still image is accessed from the memory and decoded 1032 and a similar cropping and scaling 1034 and reference frame resampling 1036 is performed on the decoded second still image as was performed on the first still image 1014, 1018, and the resultant reference frame of the second still image is used as a surrogate I-frame for inter-prediction encoding video frames of the received second video 1038. The inter-prediction encoded second video is then stored in the memory 1030. In some examples, receipt of the first and second video 1003 may be followed by an adjustment of the first and second video to align one or more visual parameters of the received first and second video with one another, such that corresponding views of a stereoscopic video are provided. The adjustment of the first still image and the second still image by cropping and scaling 1014, 1034 and reference frame resampling 1016, 1036 may in such examples be an adjustment to align the first and second still images with the visual parameters of the corresponding adjusted first and second video. In examples wherein minimal processing is required 1006, instead of the independent encoding of the second still image, the first still image may be decoded 1022 for use as a reference picture in inter-view prediction encoding of the second still image 1024, prior to storage of the encoded first and second still images 1010. In such examples requiring minimal processing 1026, the encoding of the video frames of the second video may be performed by inter-view prediction encoding 1028 using corresponding video frames of the received first video as reference frames. Examples will be appreciated wherein the decoded first still image may form all or part of the reference frame for inter-prediction encoding of the video frames of the second video. This may be the case in particular if the first still image comprises an image capture parameter providing a superior image quality, such as relative image resolution, than the second still image.

Considering the example of FIG. 8, which shows an I:P:B ratio of 0:1:7, if in a 3-second video, there are 45 frames before the reference frame comprising the still image, and there are a maximum of 7 P-frames that need to be decoded, in the reverse display order before displaying the first frame, this may provide approximately 230 ms of latency. This can of course depend on the processing capabilities of the control circuitry and can be a lot shorter on advanced hardware. Assuming an ability to playback K video at 120 fps, or even K video at 60 fps, the latency in decoding multiple frames in 1080p can be significantly reduced, e.g., 15 ms or less considering the scale. When considering the present disclosure, in an extreme example when the reference frame comprising the still image is the final frame of the video, after possible image adjustment, latency may be approximately 30 ms or less, to decode 14 P-frames of 1080p. Such examples consider decoding a single still image, which may be of a first and second still image, for flat-screen viewing. On an extended reality enabled device, such as comprising a head-mounted display (HMD), the decoding capability and processing performance may be higher than a smart phone to support fast decoding for stereoscopic video and as such the associated latency may reflect this.

The processes described above are intended to be illustrative and not limiting. One skilled in the art would appreciate that the steps of the processes discussed herein may be omitted, modified, combined, rearranged, or any combination thereof, and any additional steps may be performed without departing from the scope of the disclosure. More generally, the above disclosure is meant to be illustrative and not limiting. Only the claims that follow are meant to set bounds as to what the present disclosure includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and methods described above may be applied to, or used in accordance with, other systems and methods.

1. A method comprising:
receiving, by control circuitry, image data comprising a first video having a capture duration, and a first still image captured during the capture duration;
image encoding, by control circuitry, the first still image for storage; and
video encoding, by control circuitry, the first video via inter-prediction for storage, said inter-prediction using a reference frame as a surrogate intra-coded (I) frame, the reference frame comprising the first still image.

2. The method of claim 1, wherein the image data further comprises a second video captured simultaneous with the first video, and a second still image captured simultaneous with the first still image; and wherein:
the image encoding further comprises, image encoding the second still image; and
the video encoding further comprises, video encoding the second video via inter-prediction for storage, said inter-prediction using a reference frame as a surrogate I-frame, the reference frame comprising at least one of: the first still image; or the second still image.

3. The method of claim 2, wherein image encoding the second still image comprises inter-view prediction using the first still image as a reference picture.

4. The method of claim 2, wherein the first still image is captured using one or more first optical parameters and the second still image is captured using one or more second optical parameters different to the first optical parameters.

5. The method of claim 2, wherein the video encoding further comprises:
generating the reference frame, said generating comprising:
decoding at least one of: the encoded first still image; or the encoded second still image; and
adjusting at least one of: the decoded first still image; or the decoded second still image, said adjusting using one or more selected from: spatial alignment; cropping; scaling; resampling.

6. The method of claim 5, wherein said adjusting is based on a video frame being encoded from at least one of: the first video; or the second video, said adjusting comprising:
identifying a matched feature between:
at least one of: the first still image; or the second still image; and
the video frame being encoded; and
adjusting at least one of: the decoded first still image; or the decoded second still image, such that the generated reference frame comprises the matched feature.

7. The method of claim 5, wherein the first video and the first still image share a common first perspective, and wherein the second video and the second still image share a common second perspective; and
wherein generating the reference frame further comprises forming a stereoscopic still image from the adjusted first still image and second still image.

8. The method of claim 2, wherein the video encoding further comprises:
generating video frames to be encoded, said generating comprising:
adjusting frames of at least one of: the first video; or the second video, said adjusting using one or more selected from: spatial alignment; cropping; scaling; resampling; frame rate adjustment; aspect ratio adjustment; letter-boxing; pillar-boxing; and
excluding, for said video encoding, a video frame of the first video captured at a same time instance as the first still image and a video frame of the second video captured at a same time instance as the second still image.

9. The method of claim 8, wherein the video encoding further comprises:
resampling the reference frame, such that the resampled reference frame comprises a resolution matching a resolution of the video frames to be video encoded;
video encoding the video frames to be video encoded using the resampled reference frame.

10. The method of claim 8 wherein the video encoding further comprises:
encoding the video frames to be encoded via inter-prediction using the reference frame in a reverse display order from a time instance of the reference frame; and
encoding the video frames to be encoded via inter-prediction using the reference frame in a forward display order from a time instance of the reference frame.

11. A system comprising control circuitry configured to:
receive image data comprising a first video having a capture duration, and a first still image captured during the capture duration;
image encode the first still image for storage; and
video encode the first video via inter-prediction for storage, said inter-prediction using a reference frame as a surrogate intra-coded (I) frame, the reference frame comprising the first still image.

12. The system of claim 11, wherein the image data further comprises a second video captured simultaneous with the first video, and a second still image captured simultaneous with the first still image; and wherein:
the image encoding further comprises, image encoding the second still image; and
the video encoding further comprises, video encoding the second video via inter-prediction for storage, said inter-prediction using a reference frame as a surrogate I-frame, the reference frame comprising at least one of: the first still image; or the second still image.

13. The system of claim 12, wherein image encoding the second still image comprises inter-view prediction using the first still image as a reference picture.

14.-17. (canceled)

18. The system of claim 12, wherein the video encoding further comprises:
generating video frames to be encoded, said generating comprising:
adjusting frames of at least one of: the first video; or the second video, said adjusting using one or more selected from: spatial alignment; cropping; scaling; resampling; frame rate adjustment;
aspect ratio adjustment; letter-boxing; pillar-boxing; and
excluding, for said video encoding, a video frame of the first video captured at a same time instance as the first still image and a video frame of the second video captured at a same time instance as the second still image.

19.-50. (canceled)

51. The method of claim 1, wherein the video encoding generates an encoded video wherein all frames of the encoded video are predicted frames.

52. The method of claim 1, further comprising storing the encoded video, wherein all frames of the encoded video are predicted frames.

53. The method of claim 1, further comprising:
removing from the first video, prior to the video encoding, a video frame that corresponds to time instance when the first still image was captured;
wherein the video encoding comprises generating an encoded video based on the first video that has been modified to remove the video frame that corresponds to the time instance when the first still image was captured; and
storing the encoded video.

54. The system of claim 11, wherein the video encoding generates an encoded video wherein all frames of the encoded video are predicted frames.

55. The system of claim 11, wherein the control circuitry is further configured to:
store the encoded video, wherein all frames of the encoded video are predicted frames.

56. The system of claim 11, wherein the control circuitry is further configured to:
remove from the first video, prior to the video encoding, a video frame that corresponds to time instance when the first still image was captured;
wherein the video encoding comprises generating an encoded video based on the first video that has been modified to remove the video frame that corresponds to the time instance when the first still image was captured; and
storing the encoded video.
